(19) United States
(12) Patent Application Publication
(10) Pub. No.: US 2013/0051470 A1
(43) Pub. Date: Feb. 28, 2013

(54) MOTION COMPENSATED FRAME GENERATING APPARATUS AND METHOD

(71) Applicant: Hiroshi Noguchi, Yokohama-shi (JP)

(72) Inventor: Hiroshi Noguchi, Yokohama-shi (JP)

(73) Assignee: JVC KENWOOD CORPORATION, Yokohama-shi (JP)

(21) Appl. No.: 13/595,628

(22) Filed: Aug. 27, 2012

(30) Foreign Application Priority Data
Aug. 29, 2011 (JP) P2011-186245

(51) Int. Cl. H04N 7/32

(52) U.S. Cl. 375/240.14; 375/E07.125

(57) ABSTRACT

A motion vector detector detects a motion vector, and outputs a block matching error value. An entire scroll determiner generates an entire scroll degree. Based on the block matching error value, a reliability generator generates reliability data indicating reliability of the motion vector. A reliability adjuster adjusts the reliability data so that a value of the reliability data is larger as the entire scroll degree is a value in which the degree at which the image scrolls entirely is larger, and outputs adjusted reliability data. Based on the adjusted reliability data, the interpolation pixel generator generates respective interpolation pixels composing a motion compensated frame.

### CROSS REFERENCE TO RELATED APPLICATION

This application is based upon and claims the benefit of priority under 35 U.S.C. §119 from Japanese Patent Application No. P2011-186245, filed on Aug. 29, 2011, the entire contents of which are incorporated herein by reference.

### BACKGROUND

Embodiments relate to a motion compensated frame generating apparatus and method, which detect a motion of an image and generate a compensated frame to be interpolated between actual frames.

In order to reduce blurring of a moving picture in the event of displaying the moving picture on a liquid crystal display and the like, a frame rate is converted by using a motion compensated frame generating method. In the motion compensated frame generating method, a motion of an image is detected, and a compensated frame is generated. Accordingly, in the case of making a mistake in detecting the motion, a region generated by erroneous compensation will be included in the compensated frame. Hence, image quality is deteriorated.

Accordingly, for a video signal processing device such as a frame rate conversion device using the motion compensated frame generating method, it is required to accurately detect the motion of the image and to enhance motion compensation quality.

### SUMMARY

In the motion compensated frame generating apparatus and method, in the event of generating the respective interpolation pixels which compose the compensated frame, static interpolation processing and dynamic interpolation processing are used properly in response to a motion vector representing the motion of the image, and interpolation pixels by the static interpolation processing and interpolation pixels by the dynamic interpolation processing are mixed with each other.

If the motion vector is erroneously detected, then not only motion compensation is performed by a wrong vector, but also such proper use of the static interpolation processing and the dynamic interpolation processing and a way of mixing the interpolation pixels by the static interpolation processing and the interpolation pixels by the dynamic interpolation processing with each other become inappropriate. These cause erroneous motion compensation.

It is desired that the motion vector not be erroneously detected but be accurately detected; however, it is difficult to accurately detect the motion vector completely free from such erroneous detection. As described in Japanese Patent No. 3883589, as a method of enhancing the motion compensation quality, there is a method of evaluating reliability of the motion vector by a block matching error value, and changing a mixing ratio of the interpolation pixels by the static interpolation processing and the interpolation pixels by the dynamic interpolation processing with each other in response to the reliability.

However, even if the mixing ratio is simply changed in response to the reliability of the motion vector, which is based on the block matching error value, the blurring of the moving picture sometimes occurs, resulting in that the motion compensation quality cannot be enhanced, and an improvement thereon is required.

It is an object of the embodiments to provide motion compensated frame generating apparatus and method, which are capable of further improving the blurring of the moving picture, and capable of enhancing the motion compensation quality to a large extent.

In order to solve such a problem as mentioned above, which is inherent in the conventional technology, a first aspect of the embodiments provides a motion compensated frame generating apparatus including: a motion vector detector configured to define, as a focused unit of detection, a predetermined unit of detection in an actual frame in a video signal, to detect a motion vector directed toward a unit of detection, the unit having a highest correlation with the focused unit of detection, by using block matching from among a plurality of motion vector candidates directed toward plural units of detection, the units being included in a predetermined search range in another actual frame, and to output a block matching error value individually for the focused unit of detection, the block matching error value corresponding to the motion vector; an entire scroll determiner configured to, based on the motion vector, generate an entire scroll degree indicating a degree at which an image scrolls entirely; a reliability generator configured to, based on the block matching error value, generate reliability data indicating reliability of the motion vector; a reliability adjuster configured to adjust the reliability data so that a value of the reliability data is larger as the entire scroll degree is a value in which the degree at which the image scrolls entirely is larger, and to output the reliability data as adjusted reliability data; and an interpolation pixel generator configured to, based on the adjusted reliability data, increase a ratio of dynamic interpolation processing that uses the motion vector between static interpolation processing that does not use the motion vector and the dynamic interpolation processing as the reliability of the motion vector is larger, and to generate respective interpolation pixels composing a motion compensated frame, wherein the entire scroll determiner includes: a boundary determining signal generator configured to compare the motion vectors between different units of detection in one actual frame among the motion vectors detected by the motion vector detector, thereby to determine whether or not a boundary between the motion vectors in the different units of detection exists, and to generate a motion vector boundary determining signal; a boundary determining signal accumulator configured to accumulate a plurality of the motion vector boundary determining signals generated by the boundary determining signal generator, and to generate an accumulated value indicating a degree at which the boundary between the motion vectors exists in one actual frame; and a determiner configured to compare the accumulated value and a predetermined threshold value with each other, and thereby to generate the entire scroll degree.

A second aspect of the embodiments provides a motion compensated frame generating method including the steps of: defining, as a focused unit of detection, a predetermined unit of detection in an actual frame in a video signal, and calculating, by block matching, a degree of correlation of each of a plurality of motion vector candidates directed from the focused unit of detection toward plural units of detection, the units being included in a predetermined search range in another actual frame, with the focused unit of detection; detecting a motion vector directed toward a unit of detection, the unit having a highest correlation with the focused unit of detection, among the plurality of motion vector candidates; outputting a degree of correlation individually for the focused unit of detection as a block matching error value, the block matching error value corresponding to the motion vector; based on the motion vector, generating an entire scroll degree indicating a degree at which an image scrolls entirely; based on the block matching error value, generating reliability data indicating reliability of the motion vector; adjusting the reliability data so that a value of the reliability data is larger as the entire scroll degree is a value in which the degree at which the image scrolls entirely is larger, and outputting the reliability data as adjusted reliability data; and based on the adjusted reliability data, increasing a ratio of dynamic interpolation processing that uses the motion vector between static interpolation processing that does not use the motion vector and the dynamic interpolation processing as the reliability of the motion vector is larger, and generating respective interpolation pixels composing a motion compensated frame, wherein the step of generating the entire scroll degree includes the steps of: comparing the motion vectors between different units of detection in one actual frame among the motion vectors detected by the step of detecting a motion vector, thereby determining whether or not a boundary between the motion vectors in the different units of detection exists, and generating a motion vector boundary determining signal; accumulating a plurality of the motion vector boundary determining signals, and generating an accumulated value indicating a degree at which the boundary between the motion vectors exists in one actual frame; and comparing the accumulated value and a predetermined threshold value with each other, and thereby generating the entire scroll degree.

### BRIEF DESCRIPTION OF THE DRAWINGS

FIG. 1 is a block diagram showing a motion compensated frame generating apparatus of a first embodiment.

FIG. 2 is a view for explaining a motion vector detecting operation in a motion vector detector 12a in FIG. 1.

FIG. 3 is a view for explaining thinning of candidates for a motion vector in the motion vector detector 12a in FIG. 1.

FIG. 4 is a flowchart showing a generating operation of an entire scroll degree DS in an entire scroll determiner 13a in FIG. 1.

FIG. 5 is a view for explaining processing of Step S4 in FIG. 4.

FIG. 6 is a characteristic diagram showing a characteristic example of the entire scroll degree DS.

FIG. 7 is a characteristic diagram showing a characteristic example of reliability data DR1 to be generated by a reliability generator 14 in FIG. 1.

FIG. 8 is a characteristic view showing a characteristic example adjusted reliability data DR2 to be generated by a reliability adjustor 15 in FIG. 1.

FIG. 9 is a view for explaining static interpolation processing in a static interpolator 161 in FIG. 1

FIG. 10 is a view for explaining dynamic interpolation processing in a dynamic interpolator 162 in FIG. 1.

FIG. 11 is a block diagram showing a motion compensated frame generating apparatus of a second embodiment.

FIG. 12 is a block diagram showing a specific configuration example of an entire scroll determiner 13b in FIG. 11.

FIG. 13 is a view for explaining a boundary determining operation in a horizontal motion vector boundary determiner 131 and a vertical motion vector boundary determiner 132 in FIG. 12.

FIGS. 14A-14G are views showing other examples of the boundary determining operation.

FIG. 15 is a view for explaining an accumulating operation in a boundary determining signal accumulator 134 in FIG. 12.

FIG. 16 is a flowchart showing the accumulating operation in the boundary determining signal accumulator 134.

FIG. 17 is a characteristic diagram showing a characteristic example in an event where the entire scroll determiner 13b generates the entire scroll determining degree DS.

FIG. 18 is a characteristic diagram showing a characteristic example in an event where the horizontal motion vector boundary determiner 131 generates a boundary determining value MV_H_LEFT.

FIG. 19 is a block diagram showing a motion compensated frame generating apparatus of a third embodiment.

FIG. 20 is a block diagram showing a motion compensated frame generating apparatus of a fourth embodiment.

FIG. 21 is a view for explaining a determining method of a vector coincidence degree in a vector coincidence determiner 19 in FIG. 20.

### DETAILED DESCRIPTION

A description is made below of the respective embodiments of motion compensated frame generating apparatus and method with reference to the accompanying drawings.

### First Embodiment

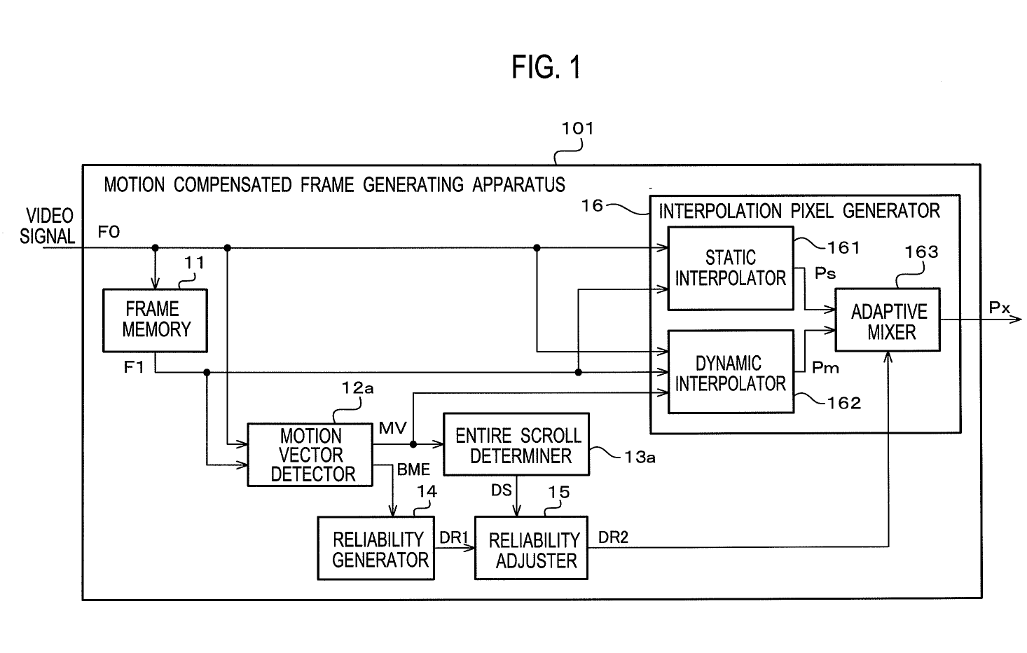

FIG. 1 shows a motion compensated frame generating apparatus 101 of a first embodiment. The motion compensated frame generating apparatus 101 includes: a frame memory 11; a motion vector detector 12a; an entire scroll determiner 13a; a reliability generator 14; a reliability adjuster 15; and an interpolation pixel generator 16. The interpolation pixel generator 16 includes: a static interpolator 161; a dynamic interpolator 162; and an adaptive mixer 163.

In FIG. 1, a video signal is inputted to the frame memory 11, the motion vector detector 12a and the interpolation pixel generator 16. It is defined that an actual frame to be inputted to the frame memory 11, the motion vector detector 12a and the interpolation pixel generator 16 is a current frame F0.

The frame memory 11 delays the video signal of the current frame F0 by one frame period and outputs the video signal concerned. It is defined that an actual frame, which is outputted from the frame memory 11, and is past by one frame with respect to the current frame F0, is a past frame F1. A video signal of the past frame F1 is inputted to the motion vector detector 12a and the interpolation pixel generator 16.

The motion vector detector 12a detects a motion vector for each unit of detection on the past frame F1 by using the video signals of the current frame F0 and the past frame F1.

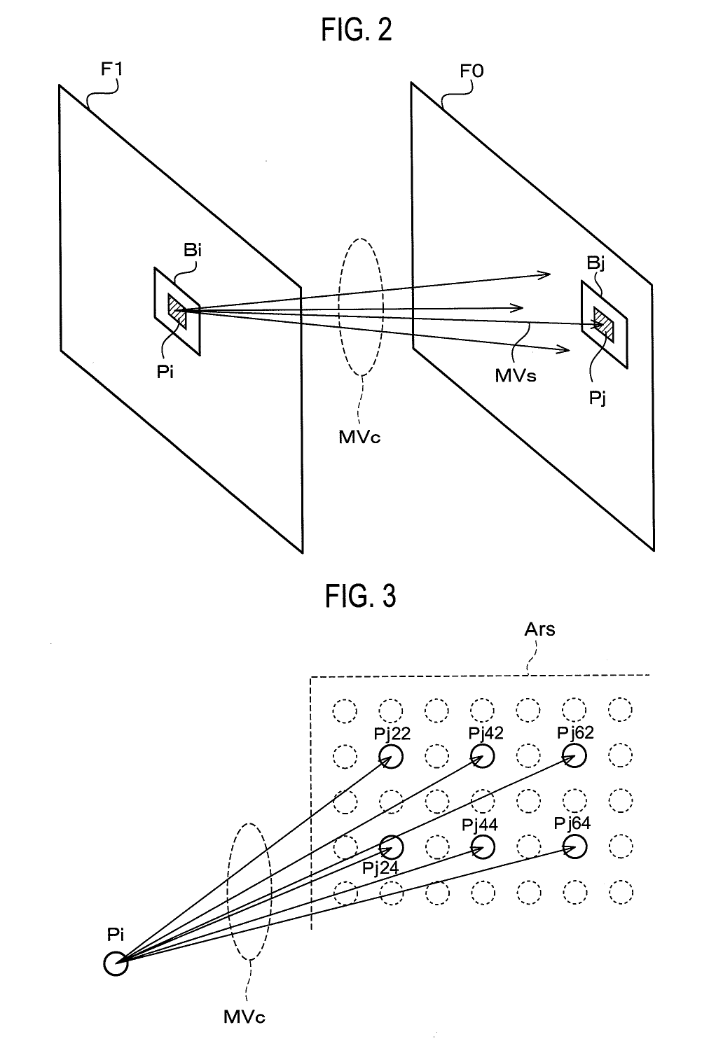

Here, by using FIG. 2, a description is made of a detection operation of the motion vector by the motion vector detector 12a. In FIG. 2, it is assumed to detect a motion vector with respect to a focused pixel Pi located on a predetermined coordinate (x, y) in the past frame F1. The motion vector detector 12a defines, as a search range, a range, for example, ±40 pixels with respect to the respective x and y of the predetermined coordinate (x, y) on the current frame F0.

From among plural candidates MVc for the motion vector that is directed from the focused pixel Pi toward a pixel to be described later, which is selected in the search range, the motion vector detector 12a detects a motion vector MVs that is directed toward a pixel Pj in the current frame F0, the pixel Pj having a highest correlation with the focused pixel Pi.

In the first embodiment, as an example of an index to determine the correlation, a sum of absolute differences (SAD) in luminance between two frames is used. The motion vector detector 12a calculates a value of the SAD by Expression (1), for example, by using the respective pixels in a block Bi with seven pixels in a horizontal direction and seven pixels in a vertical direction on a periphery of the focused pixel Pi and using the respective pixels in a block Bj with seven pixels in the horizontal direction and seven pixels in the vertical direction on a periphery of the pixel Pj as shown in FIG. 2.

In Expression (1), (mvx_c, mvy_c) is each of motion vector candidates corresponding to such motion vector candidates MVc of FIG. 2, SAD (mvx_c, mvy_c) is such an SAD value with respect to such a motion vector candidate (mvx_c, mvy_c), L0 (x, y) and L1 (x, y) are luminance values of the pixels at the coordinate (x, y) in the current frame F0 and the past frame F1, respectively.

$$SAD ( mvx\_c , mvy\_c ) = {\sum }_{m = - 3}^{m = 3} {\sum }_{n -= 3}^{n = 3} \vert L 1 ( x + n , y + m ) - L 0 ( x\_n + mvx\_c , y + m + mvy\_c ) \vert \qquad ( 1 )$$

A pixel, in which the SAD value calculated by Expression (1) becomes minimum, has the highest correlation. The motion vector detector 12a extracts the motion vector MVs, which is directed toward the pixel Pj having the minimum SAD value, from among the plurality of motion vector candidates MVc, and outputs the extracted motion vector MVs as a motion vector MV.

In the first embodiment, in order to reduce a circuit scale of the motion vector detector 12a and an amount of calculation to be performed in the motion vector detector 12a, motion vector candidates MVc, which are directed from the focused pixel Pi toward all of the pixels in the search range, are not obtained, but as shown in FIG. 3, motion vector candidates MVc, which are directed toward pixels selected in the horizontal direction and the vertical direction, are configured to be obtained.

In an example shown in FIG. 3, odd-number lines in the vertical direction in the search range Ars shown by a broken line are thinned, and in addition, odd-number pixels in the horizontal direction are thinned. In FIG. 3, a circular shape indicates the pixels, and circles indicated by broken lines in the search range Ars are the thinned pixels.

The motion vector detector 12a detects the motion vector MVs, which is directed from the focused pixel Pi toward the pixel Pj having the highest correlation, from among the plurality of motion vector candidates MVc, which are directed from the focused pixel Pi concerned toward pixels Pj22, Pj42, Pj62 . . . , Pj24, Pj44, Pj64 . . . shown by solid lines and located at an interval of every other pixel individually in the horizontal direction and the vertical direction.

That is to say, the motion vector detector 12a thins the odd-number lines in the search range Ars and the odd-number pixels in the search range Ars, and accordingly, thins odd-number motion vector candidates in the horizontal direction and the vertical direction, and detects the motion vector MVs from even-number motion vector candidates. In place of the odd-number motion vector candidates, the even-number motion vector candidates may be thinned.

Returning to FIG. 1, the motion vector detector 12a supplies the SAD value, which corresponds to the detected motion vector MV, as a block matching error value BME to the reliability generator 14. The motion vector detector 12a normalizes the block matching error value BME so that a maximum value thereof can be 255, and outputs the normalized block matching error value BME.

The unit of detection of the motion vector MV, the search range of the motion vector MV and the index of the correlation in the motion vector detector 12a are not limited to the above-described example. In the case of using the SAD value as the index of the correlation, a size and shape of the blocks Bi and Bj are not limited to the above-described example. In the case where the unit of the detection of the motion vector MV is not such a pixel unit but a block unit, a focused unit is not the focused pixel Pi but a focused block.

The motion vector detector 12a may detect the motion vector MV not by using the pixels in two frames which are adjacent to each other as shown in FIG. 2 but by using pixels in two frames which are not adjacent to each other. In order to enhance detection accuracy of the motion vector MV, the motion vector detector 12a may detect the motion vector MV by using pixels in frames more than two frames. A detection method of the motion vector MV in the motion vector detector 12a is arbitrary.

The motion vector MV detected by the motion vector detector 12a is inputted to the entire scroll determiner 13a and the dynamic interpolator 162 in the interpolation pixel generator 16. The entire scroll determiner 13a determines whether or not so-called entire scroll in which an image is entirely scrolled substantially in one direction in the frame is performed, and generates an entire scroll degree DS indicating a degree of the entire scroll.

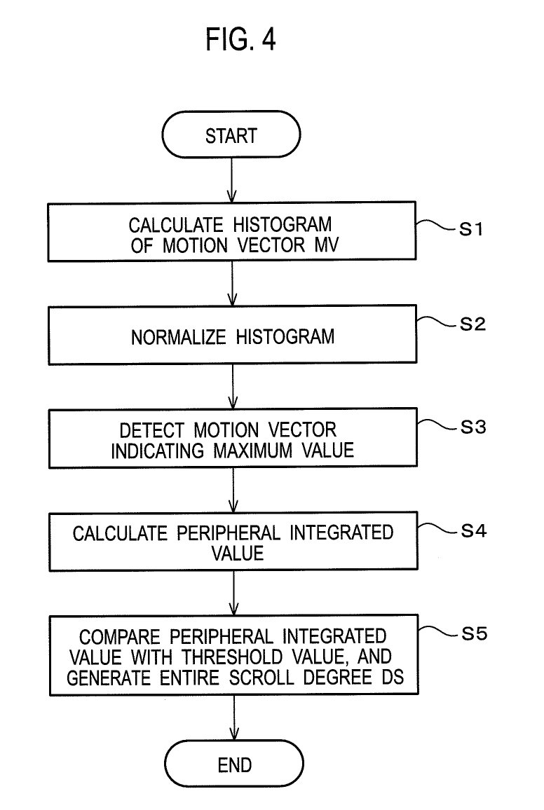

By using FIG. 4, a description is made of a generating operation of the entire scroll degree DS in the entire scroll determiner 13a. In Step S1, the entire scroll determiner 13a detects histograms of the motion vectors MV in one frame. The entire scroll determiner 13a has counters corresponding to each of the motion vectors MV different in direction from one another.

The entire scroll determiner 13a resets the counters at the time when the frame is started, and gives an increment to the counters every time when each of the motion vectors MV is inputted until the one frame is ended, and calculates a histogram value Hist (mvx_c, mvy_c) corresponding to each of the motion vectors MV.

In Step S2, the entire scroll determiner 13a normalizes the histogram value Hist (mvx_c, mvy_c) based on Expression (2) so that the value concerned can remain within a range of 0 to 255, and outputs the histogram value Hist (mvx_c, mvy_c) concerned as a normalized histogram value Hist_nrm (mvx_c, mvy_c).

Total_num in Expression (2) is a total input number of the motion vectors MV to be inputted to the entire scroll determiner 13a during a period of one frame. The range of the normalized value is not limited to 0 to 255. It is preferable to provide such normalization processing of Step S2; however, it is possible to omit the normalization processing.

Hist_{—}nrm(mvx_{—}c,mvy_{—}c)=Hist(mvx_{—}c,mvy_{—}c)×255/Total_num (2)

Note that, if the motion vectors MV are detected for all the pixels in one frame, then Total_num becomes the number of pixels of one frame. At upper and lower or left and right end portions of a screen, the detection accuracy of the motion vectors MV is not so good. Accordingly, within a predetermined range of a center portion of the screen, which excludes the upper, lower, left and right end portions in one frame, the histogram value Hist (mvx_c, mvy_c) of the motion vector MV may be calculated. In this case, Total_num becomes a total input number of the motion vector MV detected at the center portion in one frame period.

In Step S3, the entire scroll determiner 13a detects a maximum value in the normalized histogram value Hist_nrm(mvx_c, mvy_c). Specifically, the entire scroll determiner 13a detects a histogram value Hist_nrm(mvx_c_hmax, mvy_c_hmax) that indicates a maximum value (maximum frequency) among the normalized histogram values Hist_nrm(mvx_c, mvy_c).

A motion vector from which a maximum histogram value is detected among the motion vectors MV is defined as a maximum value motion vector (mvx_c_hmax, mvy_c_hmax). The maximum value motion vector (mvx_c_hmax, mvy_c_hmax) is an entire scroll motion vector indicating a direction of the entire scroll of the image.

Next, in Step S4, based on Expression (3), the entire scroll determiner 13a calculates a peripheral integrated value Sum_Hist obtained by integrating the maximum histogram value Hist_nrm(mvx_c_hmax, mvy_c_hmax) in the normalized histogram values Hist_nrm(mvx_c, mvy_c) and histogram values corresponding to the motion vectors on the periphery of the maximum value motion vector (mvx_c_hmax, mvy_c_hmax) with each other.

$$Sum\_Hist = {\sum }_{m = - 1}^{m = 1} {\sum }_{n -= 1}^{n = 1} Hist\_nrm ( mvx\_c \_hmax + 2 n , mvy\_c \_hmax + 2 m ) \qquad ( 3 )$$

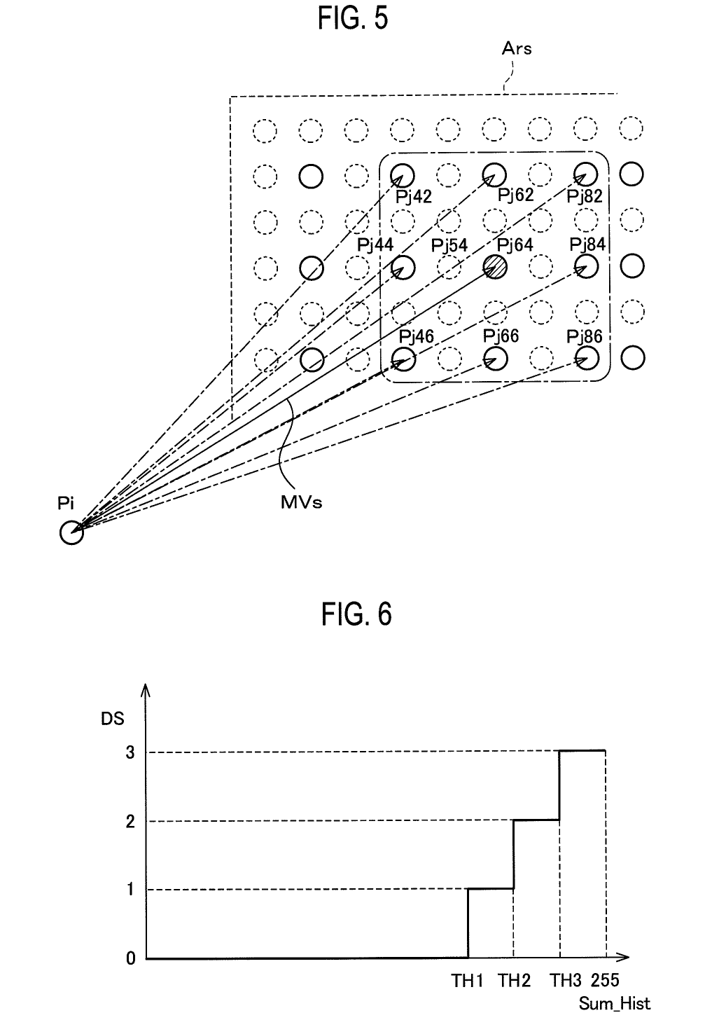

By using FIG. 5, a description is conceptually made of a calculating operation of the peripheral integrated value Sum-Hist in Step S4. In FIG. 5, it is assumed that the pixel Pj64 hatched in the search range Ars is the pixel Pj having the highest correlation with the focused pixel Pi.

As mentioned above, the odd-number motion vector candidates are thinned in the motion vector detector 12a, and for example, the motion vector directed from the focused pixel Pi toward the pixel Pj54 of FIG. 5 becomes, in the horizontal direction, a motion vector directed toward the pixel Pj44 or a motion vector directed toward the pixel Pj64. The motion vector directed toward the original pixel Pj54 is distributed to either of the motion vector directed toward the pixel Pj44 and the motion vector directed toward the pixel Pj64.

Hence, in the case where the image is a scroll image with the odd-number motion vectors, a value of the maximum value motion vector to be originally detected will be dispersed to the even-number motion vectors in the vicinity of the odd-number motion vector. Accordingly, the peripheral integrated value Sum_Hist is calculated by Expression (3) in order to integrate the normalized histograms Hist_nrm(mvx_c, mvy_c) thus dispersed with one another. In Expression (3), within a range of the pixel Pj64 and the pixels Pj42, Pj62, Pj82, Pj44, Pj84, Pj46, Pj66 and Pj86 on the periphery of the pixel Pj64, the range being surrounded by a dot-and-dash line in FIG. 5, values of the normalized histograms Hist_norm(mvx_c, mvy_c) are integrated.

The reason of shifting an x-component and y-component of the motion vector candidate MVc by two individually in Expression (3) is that the odd-number motion vector candidates are thinned. Such an integration range where the peripheral integrated value Sum_Hist is calculated is not limited to the example shown in FIG. 5.

Returning to FIG. 4, in Step S5, the entire scroll determiner 13a compares the peripheral integrated value Sum_Hist with a predetermined threshold value, and generates and outputs the entire scroll degree DS.

FIG. 6 shows an example of characteristics of the entire scroll degree DS with respect to the peripheral integrated value Sum_Hist. As shown in FIG. 6, when the peripheral integrated value Sum_Hist is equal to or more than a threshold value TH3, the entire scroll degree DS is set at “3”, when the peripheral integrated value Sum_Hist is equal to or more than a threshold value TH2 to less than the threshold value TH3, the entire scroll degree DS is set at “2”, when the peripheral integrated value Sum_Hist is equal to or more than a threshold value TH1 to less than the threshold value TH2, the entire scroll degree DS is set at “1”, and when the peripheral integrated value Sum_Hist is less than the threshold value TH1, the entire scroll degree DS is set at “0”.

The larger value of the entire scroll degree Ds stands for that the degree of the entire scroll of entirely scrolling the image in the frame substantially in one direction is larger.

In the example of FIG. 6, the entire scroll degree Ds is classified into four stages of “0” to “3”; however, is not limited to this. The entire scroll degree DS may be classified into two stages of “0” and “1”, that is, may be used for determining whether or not the entire scroll is performed. The degree of the entire scroll includes the case where the entire scroll degree DS is classified into two stages of “0” and “1”. The entire scroll determiner 13a supplies the entire scroll degree DS, which is generated as described above, to the reliability adjuster 15.

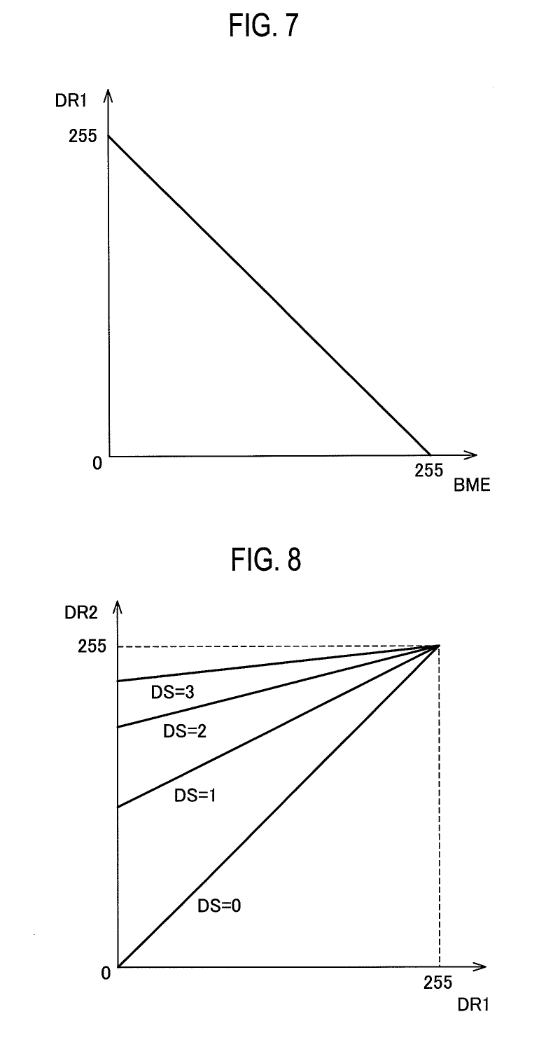

The reliability generator 14 generates reliability data DR1 as an index, which indicates reliability of the motion vector MV detected by the motion vector detector 12a, based on the block matching error value BME inputted thereto. As shown in FIG. 7, the reliability generator 14 generates the reliability data DR1, which becomes larger as the block matching error value BME is smaller, and becomes smaller as the block matching error value BME is larger. The reliability data DR1 is inputted to the reliability adjuster 15.

The reliability adjuster 15 performs gain adjustment for the reliability data DR1, which is inputted thereto, in response to the value of the entire scroll degree DS, and then outputs the reliability data DR1 as adjusted reliability data DR2. As shown in FIG. 8, the reliability adjuster 15 performs the gain adjustment so as to increase a lower limit value of the adjusted reliability data DR2 as the value of the entire scroll degree DS is larger.

As understood from characteristics shown in FIG. 8, as the value of the entire scroll degree DS is larger, the reliability adjuster 15 increases the value of the adjusted reliability data DR2 and raises the reliability. The adjusted reliability data DR2 is inputted to the adaptive mixer 163 of the interpolation pixel generator 16.

Next, a description is made of an operation of the interpolation pixel generator 16. The static interpolator 161 always generates an interpolation pixel in a compensated frame F10 between the current frame F0 and the past frame F1 by static interpolation processing by using the pixel in the current frame F0 and the pixel in the past frame F1, which are inputted thereto.

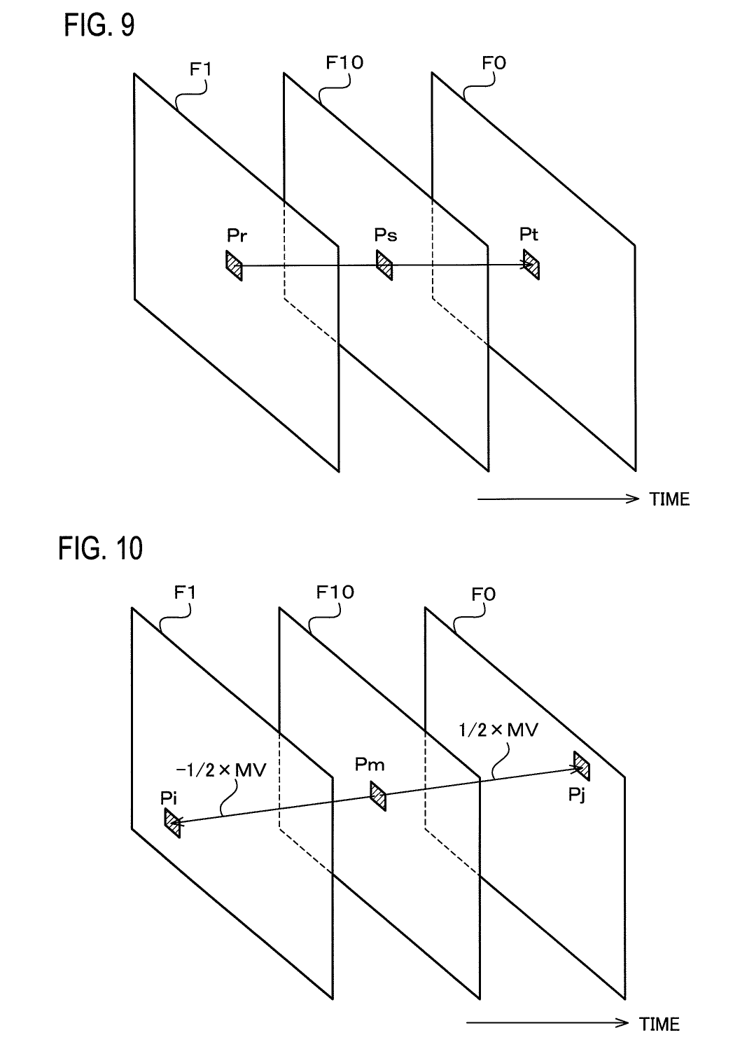

Specifically, as shown in FIG. 9, the static interpolator 161 generates an interpolation pixel Ps in the compensated frame F10 between the current frame F0 and the past frame F1 by averaging a pixel Pr in the past frame F1 and a pixel Pt in the current frame F0, which are individually located at the same position as that of the interpolation pixel Ps.

The dynamic interpolator 162 generates an interpolation pixel in the compensated frame F10 between the current frame F0 and the past frame F1 by dynamic interpolation processing, which is based on the motion vector MV, by using the pixel in the current frame F0, the pixel in the past frame F1 and the motion vector MV, which are inputted thereto.

Specifically, as shown in FIG. 10, in the event of generating the interpolation pixel Pm in the compensated frame F10, there are used: a motion vector ½×MV obtained by halving (multiplying, by ½) the motion vector MV detected in the pixel in the past frame F1, which is located at the same position as that of the interpolation pixel Pm; and a motion vector −½×MV obtained by halving the motion vector MV concerned and reversing a sign thereof (multiplying, by −½). The dynamic interpolator 162 generates the interpolation pixel Pm by averaging the pixel Pi in the past frame F1, which is indicated by the motion vector −½×MV, and the pixel Pj in the current frame F0, which is indicated by the motion vector ½×MV.

Though not particularly shown, the dynamic interpolator 162 includes a delay circuit that individually delays the pixel in the current frame F0 and the pixel in the past frame F1, which are inputted thereto, in the horizontal direction and the vertical direction, so as to be capable of selecting the pixel Pi and the pixel Pj within a predetermined range of a plurality of the pixels in the horizontal direction and the vertical direction, in which the interpolation pixel Pm is taken as a center.

In the first embodiment, the interpolation processing of the static interpolator 161 and the dynamic interpolator 162 is performed by using the pixels in the two frames which are adjacent to each other as shown in FIG. 9 and FIG. 10; however, the interpolation processing may be performed by using pixels in two frames which are not adjacent to each other.

To the adaptive mixer 163, there are inputted: the interpolation pixel Ps outputted from the static interpolator 161; and the interpolation pixel Pm outputted from the dynamic interpolator 162. In response to the value of the adjusted reliability data DR2, the adaptive mixer 163 adaptively mixes the interpolation pixel Ps and the interpolation pixel Pm with each other. Based on Expression (4), the adaptive mixer 163 mixes the interpolation pixel Ps and the interpolation pixel Pm with each other, and generates an interpolation pixel Px.

Px=Ps×(256−DR2)/256+Pm×DR2/256 (4)

As understood from Expression (4), in the interpolation pixel Px, a ratio of the interpolation pixel Pm generated by the dynamic interpolation processing is increased as the value of the adjusted reliability data DR2 is larger. As mentioned above, the reliability adjuster 15 increases the value of the reliability data DR1 as the value of the entire scroll degree DS to be generated by the entire scroll determiner 13a is larger, and defines the reliability data DR1, in which the value is increased, as the adjusted reliability data DR2.

That is to say, as the value of the entire scroll degree DS is larger, the interpolation pixel generator 16 reduces a ratio of the interpolation pixel Ps generated by the static interpolation processing, and increases the ratio of the interpolation pixel Pm. The interpolation pixel generator 16 increases the ratio of dynamic interpolation processing, as the reliability of the motion vector MV is larger.

As the video signal to be inputted, the respective pixels which compose the actual frame are sequentially inputted to the interpolation pixel generator 16, and such interpolation pixels Px which compose the compensated frame F10 are sequentially generated by the interpolation pixel generator 16. In such a way, from the motion compensated frame generating apparatus 101, each compensated frame F10 to be interpolated between the past frame F1 and the current frame F0 is generated.

In the first embodiment, as described with reference to FIG. 3, the motion vector candidates MVc are thinned, whereby the odd-number motion vector candidates or the even-number motion vector candidates are thinned; however, a thinning method of the motion vector candidates is not limited to the method in FIG. 3.

For example, the number of pixels of one frame is thinned to a half (½) in both of the horizontal and vertical directions, and a size of the one frame is quartered (¼). The motion vector is detected between frames with such a ¼ size. This motion vector is doubled individually in the horizontal and vertical directions, and is turned to the motion vector MV to be actually used in the motion compensated frame generating apparatus 101. In this case, the odd-number motion vector candidates are thinned.

In accordance with the motion compensated frame generating apparatus 101 of the first embodiment, the reliability of the motion vector MV is adjusted by using the entire scroll degree DS, and accordingly, the blurring of the moving picture can be further improved in comparison with the conventional, and the motion compensation quality can be enhanced to a large extent.

In the motion compensated frame generating apparatus 101 of the first embodiment, the motion vector candidates MVc are thinned in the motion vector detector 12a, and accordingly, it is made possible to reduce the circuit scale and calculation amount of the motion vector detector 12a. In addition, in the event of generating the entire scroll degree DS in the entire scroll determiner 13a, the peripheral integrated value Sum_Hist obtained by integrating the values of the peripheral histograms of the maximum value motion vector (entire scroll motion vector) with one another is used. Accordingly, the entire scroll degree DS can be accurately generated while avoiding an adverse effect owing to the thinning of the motion vector candidates.

### Second Embodiment

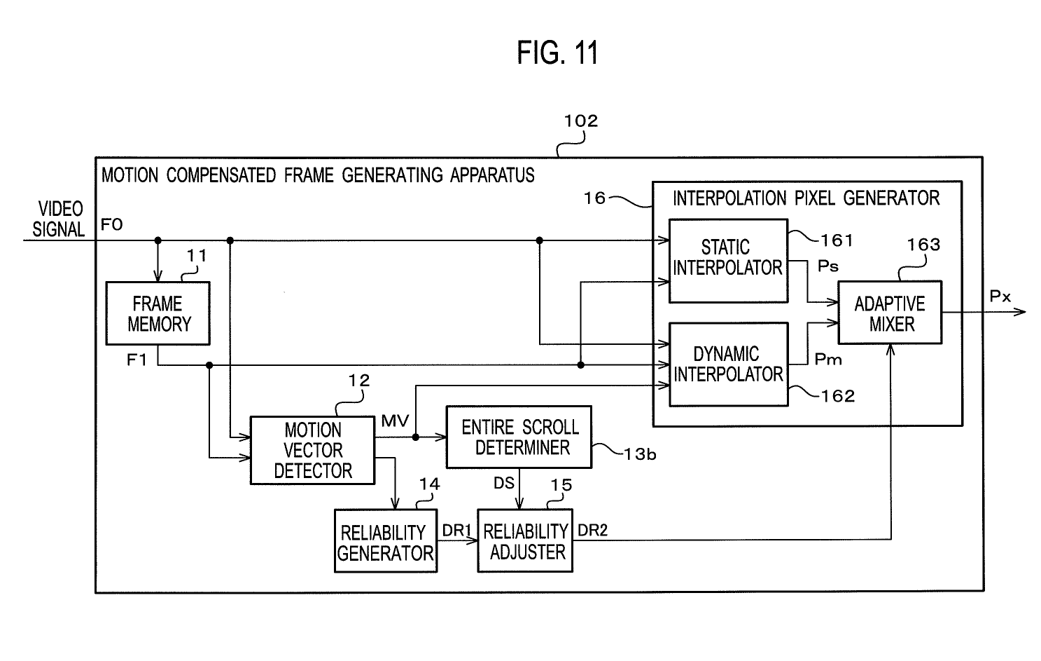

In a motion compensated frame generating apparatus 102 of a second embodiment, which is shown in FIG. 11, the same reference numerals are assigned to the same portions as those of the motion compensated frame generating apparatus 101 of the first embodiment, and a description thereof is omitted as appropriate.

A motion vector detector 12 in the motion compensated frame generating apparatus 102 of the second embodiment may be the same as the motion vector detector 12a, or may be configured to detect the motion vector MV without thinning the motion vector candidates MVc. The motion compensated frame generating apparatus 102 of the second embodiment includes an entire scroll determiner 13b, which has a different configuration of generating the entire scroll degree DS, in place of the entire scroll determiner 13a.

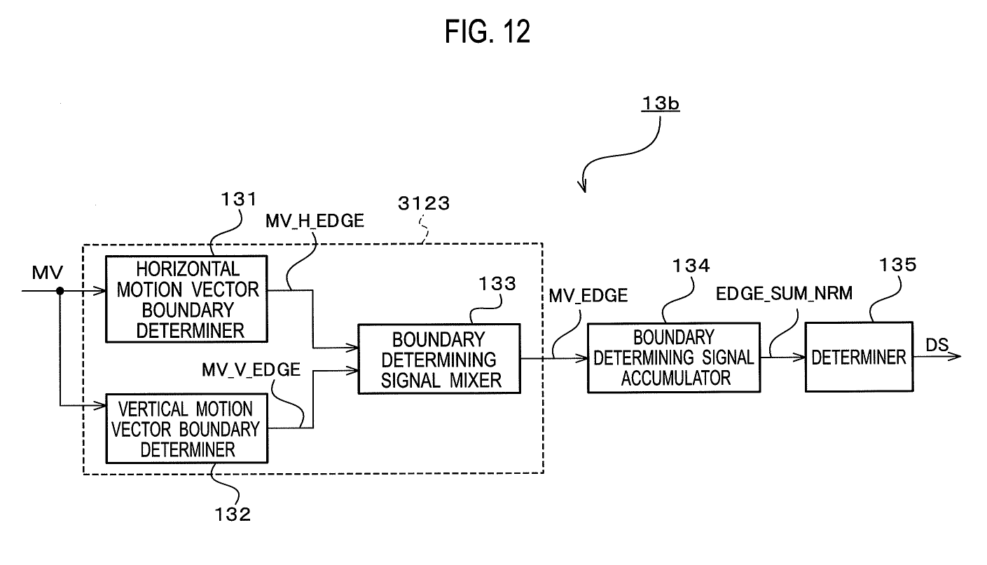

A description is made of a specific configuration of the entire scroll determiner 13b by using FIG. 12. The motion vector MV outputted from the motion vector detector 12 is inputted to a horizontal motion vector boundary determiner 131 and a vertical motion vector boundary determiner 132. The horizontal motion vector boundary determiner 131 determines a boundary between the motion vectors in the horizontal direction based on the motion vector MV. The vertical motion vector boundary determiner 132 determines a boundary between the motion vectors in the vertical direction based on the motion vector MV.

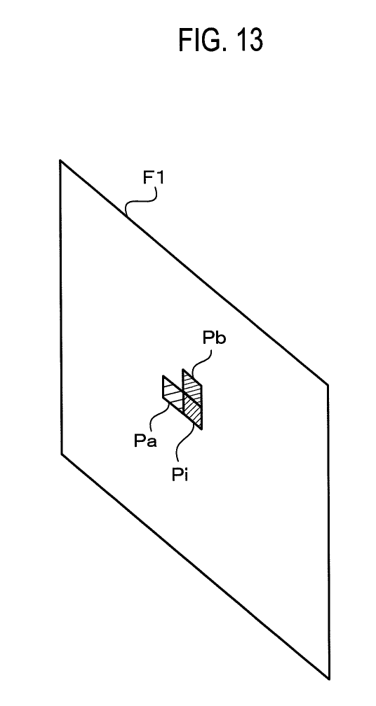

By using FIG. 13, a description is made of a method for determining the boundary between the motion vectors MV in the horizontal direction, which is to be performed by the horizontal motion vector boundary determiner 131. In FIG. 13, the motion vector MV detected in the focused pixel Pi is defined as MV_REF, the motion vector MV detected in a pixel Pa adjacent to a left side of the focused pixel Pi is defined as MV_LEFT, and the motion vector MV detected in a pixel Pb adjacent to an upper side of the focused pixel Pi is defined as MV_ABOVE.

First, by using Expression (5), the horizontal motion vector boundary determiner 131 determines whether or not there is a boundary between the motion vectors in the horizontal direction in the focused pixel Pi and the pixel Pa on the left side thereof. In Expression (5), MV_REF_H and MV_LEFT_H are horizontal components of MV_REF and MV_LEFT, and TH_H is a threshold value.

|MV_{—}REF_{—}H−MV_LEFT_{—}H|>TH_{—}H (5)

In the case where Expression (5) is satisfied, the horizontal motion vector boundary determiner 131 sets, at “1”, a boundary determining value MV_H_LEFT between the focused pixel Pi and such a left pixel Pa, and in the case where Expression (5) is not satisfied, the horizontal motion vector boundary determiner 131 sets the boundary determining value MV_H_LEFT, at “0”. The matter that the boundary determining value MV_H_LEFT is “1” indicates that the boundary exists in the horizontal components of the motion vectors MV between the focused pixel Pi and the left pixel Pa. That is to say, it is indicated that the horizontal component of the motion vector MV in the focused pixel Pi is changed with respect to the horizontal component of the motion vector MV in the left pixel Pa. Note that a value of the threshold value TH_H is appropriately set in response to the size and the like of the search range of the motion vector MV.

Next, by using Expression (6), the horizontal motion vector boundary determiner 131 determines whether or not there is a boundary between the motion vectors in the horizontal direction in the focused pixel Pi and the upper pixel Pb located immediately above the focused pixel Pi. In Expression (6), MV_ABOVE_H is a horizontal component of MV_ABOVE.

|MV_{—}REF_{—}H−MV_ABOVE_{—}H|>TH_{—}H (6)

In the case where Expression (6) is satisfied, the horizontal motion vector boundary determiner 131 sets, at “1”, a boundary determining value MV_H_ABOVE between the focused pixel Pi and the upper pixel Pb, and in the case where Expression (6) is not satisfied, the horizontal motion vector boundary determiner 131 sets the boundary determining value MV_H_ABOVE at “0”. The matter that the boundary determining value MV_H_ABOVE is “1” indicates that the boundary exists in the horizontal components of the motion vectors MV between the focused pixel Pi and the upper pixel Pb. That is to say, it is indicated that the horizontal component of the motion vector MV in the focused pixel Pi is changed with respect to the horizontal component of the motion vector MV in the upper pixel Pb.

Here, it is described that the horizontal motion vector boundary determiner 131 determines whether or not there is a boundary between the motion vectors in the horizontal direction in the focused pixel Pi and the left pixel Pa by using Expression (5), and next, determines whether or not there is a boundary between the motion vectors in the horizontal direction in the focused pixel Pi and the upper pixel Pb: however, an order of these determinations may be reverse, or these determinations may be performed simultaneously. In the second embodiment, the same threshold value TH_H is used in Expression (5) and Expression (6); however, different threshold values may be used in Expression (5) and Expression (6).

The horizontal motion vector boundary determiner 131 performs an OR operation for the boundary determining value MV_H_LEFT and the boundary determining value MV_H_ABOVE, and outputs a resultant thereof as a horizontal motion vector boundary determining signal MV_H_EDGE.

By using FIG. 13, a description is made of a method for determining the boundary between the motion vectors MV in the vertical direction, which is to be performed by the vertical motion vector boundary determiner 132. In FIG. 13, a vertical component of the motion vector MV detected in the focused pixel Pi is defined as MV_REF_V, a vertical component of the motion vector MV detected in the pixel Pa adjacent to the left side of the focused pixel Pi is defined as MV_LEFT_V, and a vertical component of the motion vector MV detected in the pixel Pb adjacent to the upper side of the focused pixel Pi is defined as MV_ABOVE_V.

By using Expression (7), the vertical motion vector boundary determiner 132 determines whether or not there is a boundary between the motion vectors in the vertical direction in the focused pixel Pi and the left pixel Pa. Moreover, by using Expression (8), the vertical motion vector boundary determiner 132 determines whether or not there is a boundary between the motion vectors in the vertical direction in the focused pixel Pi and the upper pixel Pb. TH_V is a predetermined threshold value.

In the second embodiment, the same threshold value TH_V is used in Expression (7) and Expression (8); however, different threshold values may be used in Expression (7) and Expression (8).

|MV_{—}REF_{—}V−MV_LEFT_{—}V|>TH_{—}V (7)

|MV_{—}REF_{—}V−MV_ABOVE_{—}V|>TH_{—}V (8)

In the case where Expression (7) is satisfied, the horizontal motion vector boundary determiner 132 sets, at “1”, a boundary determining value MV_V_LEFT between the focused pixel Pi and the left pixel Pa, and in the case where Expression (7) is not satisfied, the horizontal motion vector boundary determiner 131 sets the boundary determining value MV_V_LEFT at “0”. The matter that the boundary determining value MV_V_LEFT is “1” indicates that the boundary exists in the vertical components of the motion vectors MV between the focused pixel Pi and the left pixel Pa. That is to say, it is indicated that the vertical component of the motion vector MV in the focused pixel Pi is changed with respect to the vertical component of the motion vector MV in the left pixel Pa. Note that a value of the threshold value TH_V is appropriately set in response to the size and the like of the search range of the motion vector MV.

In the case where Expression (8) is satisfied, the vertical motion vector boundary determiner 132 sets, at “1”, a boundary determining value MV_V_ABOVE between the focused pixel Pi and the upper pixel Pb, and in the case where Expression (8) is not satisfied, the vertical motion vector boundary determiner 132 sets the boundary determining value MV_V_ABOVE at “0”. The matter that the boundary determining value MV_V_ABOVE is “1” indicates that the boundary exits in the vertical components of the motion vectors MV between the focused pixel Pi and the upper pixel Pb. That is to say, it is indicated that the vertical component of the motion vector MV in the focused pixel Pi is changed with respect to the vertical component of the motion vector MV in the upper pixel Pb.

The vertical motion vector boundary determiner 132 performs an OR operation for the boundary determining value MV_V_LEFT and the boundary determining value MV_V_ABOVE, and outputs a resultant thereof as a vertical motion vector boundary determining signal MV_V_EDGE.

In the example shown in FIG. 13, the motion vector MV in the focused pixel Pi is compared with the motion vectors in the left pixel Pa and the upper pixel Pb; however, comparison between the motion vectors is not limited to this.

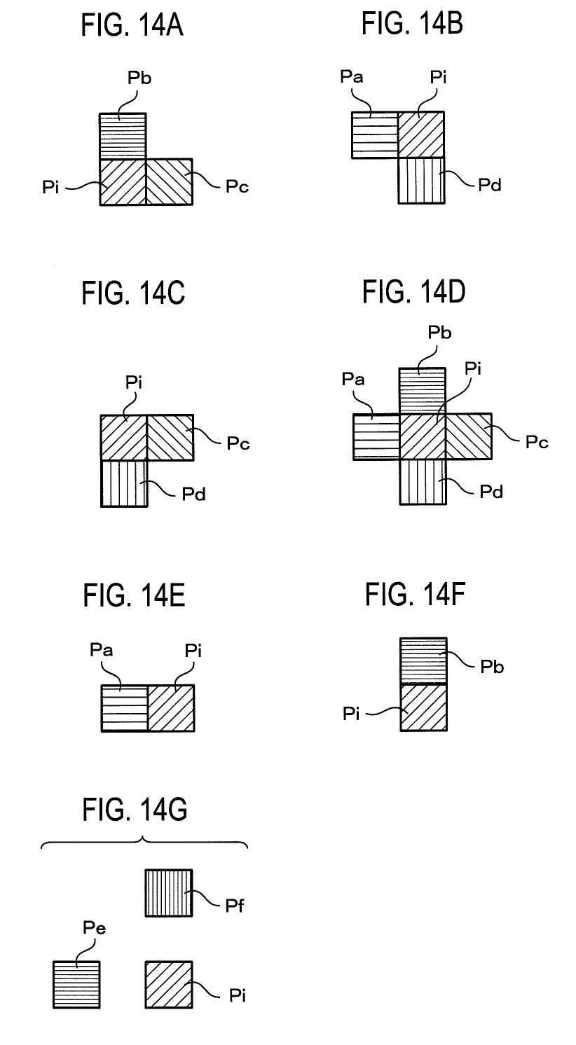

As shown in FIG. 14A, a pixel Pc adjacent to a right side of the focused pixel Pi may be used in place of the left pixel Pa, as shown in FIG. 14B, a lower pixel Pd located immediately below the focused pixel Pi may be used in place of the upper pixel Pb, as shown in FIG. 14C, such a right pixel Pc and the lower pixel Pd may be used, or as shown in FIG. 14D, the upper, lower, left and right pixels Pa, Pb, Pc and Pd may be used.

Moreover, the pixels for use in the comparison between the motion vectors MV can also be simplified by using only the left pixel Pa as shown in FIG. 14E or using only the upper pixel Pb as shown in FIG. 14F. However, in order to enhance the determination accuracy of the entire scroll, it is preferable to use both of the left or right pixel and the upper or lower pixel.

Moreover, it is not always necessary to compare the motion vector MV in the focused pixel Pi with the motion vectors MV in the pixels adjacent to the focused pixel Pi. As shown in FIG. 14G, the motion vector MV in the focused pixel Pi and the motion vector MV in a pixel Pe more on a left side of the left pixel Pa with each other, and the motion vector MV in the focused pixel Pi and the motion vector MV in a pixel Pf more on an upper side of the upper pixel Pb may be compared with each other.

That is to say, the comparison just needs to be performed for at least one of a pair of the motion vectors MV in the focused pixel Pi and the pixel located leftward of the focused pixel Pi, a pair of the motion vectors MV in the focused pixel Pi and the pixel located rightward of the focused pixel Pi, a pair of the motion vectors MV in the focused pixel Pi and the pixel located above the focused pixel Pi, and a pair of the motion vectors MV in the focused pixel Pi and the pixel located below the focused pixel Pi. Moreover, the motion vectors MV in pixels (units of detection, which are different from each other) different from the focused pixel Pi just need to be compared with each other.

In FIG. 12, to a boundary determining signal mixer 133, there are inputted: the horizontal motion vector boundary determining signal MV_H_EDGE; and the vertical motion vector boundary determining signal MV_V_EDGE. The boundary determining signal mixer 133 performs the OR operation for the horizontal motion vector boundary determining signal MV_H_EDGE and the vertical motion vector boundary determining signal MV_V_EDGE, thereby mixes both of the signals with each other, and outputs a resultant of the mixture as a motion vector boundary determining signal MV_EDGE.

As described above, a boundary determining signal generator 3123 surrounded by a broken line generates the motion vector boundary determining signal MV_EDGE. The motion vector boundary determining signal MV_EDGE is inputted to a boundary determining signal accumulator 134.

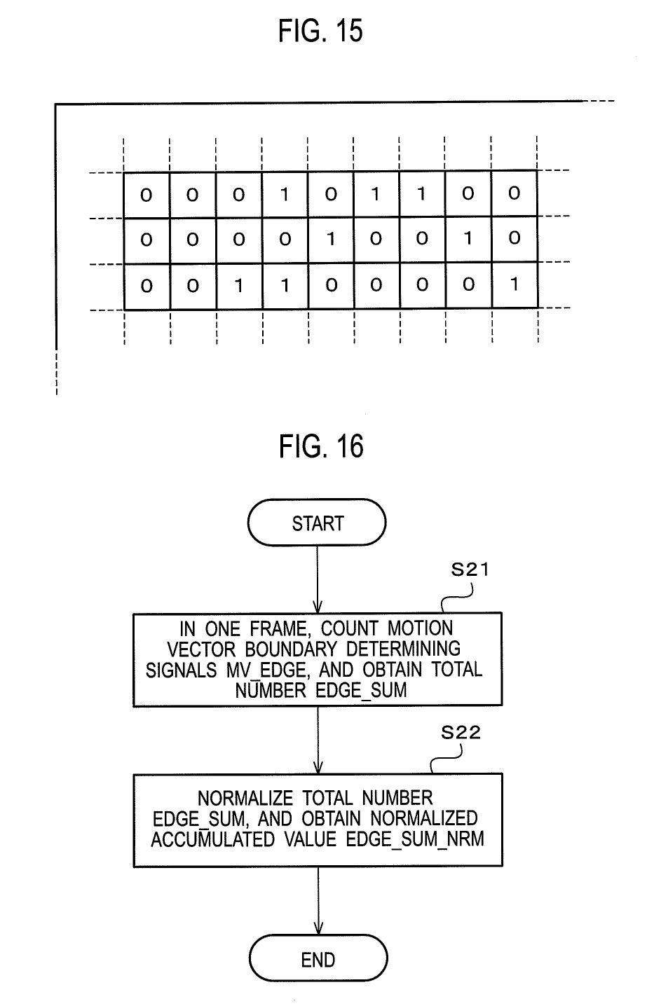

The boundary determining signal accumulator 134 accumulates such motion vector boundary determining signals MV_EDGE. In the second embodiment, the motion vector MV is detected in a unit of one pixel, and accordingly, the motion vector boundary determining signals MV_EDGE are sequentially outputted in the unit of one pixel as shown in FIG. 15. In FIG. 15, the respective rectangles represent the pixels, and “1” or “0” in the rectangles is a value indicated by the motion vector boundary determining signal MV_EDGE.

In Step S21 of FIG. 16, the boundary determining signal accumulator 134 counts the motion vector boundary determining signals MV_EDGE in one frame. That is to say, the boundary determining signal accumulator 134 gives an increment to a counter when the motion vector boundary determining signal MV_EDGE obtained for the focused pixel Pi is “1”, then accumulates the motion vector boundary determining signal MV_EDGE in one frame, and obtains a total number EDGE_SUM.

Next, in Step S22, the boundary determining signal accumulator 134 normalizes the total number EDGE_SUM by using Expression (9), and outputs a normalized accumulated value EDGE_SUM_NRM. In Expression (9), TOTAL_NUM stands for a maximum value which the total number EDGE_SUM can take. In the second embodiment, the motion vector boundary determining signals MV_EDGE are represented by binary values, and accordingly, TOTAL_NUM is a total number of the units of detection of the motion vector boundary determining signal MV_EDGE in one frame. That is to say, the motion vector boundary determining signals MV_EDGE are outputted in the unit of one pixel, and accordingly, the value of TOTAL_NUM becomes a total number of the pixels in one frame.

EDGE_SUM_{—}NRM=EDGE_SUM×255/TOTAL_NUM (9)

The motion vector boundary determining signals MV_EDGE which can be obtained for all the pixels in one frame may be accumulated; however, the motion vector boundary determining signals MV_EDGE which can be obtained for partial pixels in one frame may be accumulated. As mentioned above, at the upper and lower or left and right end portions of the screen, the detection accuracy of the motion vectors MV is not so good. Accordingly, within the predetermined range of the center portion of the screen, which excludes the upper, lower, left and right end portions in one frame, the motion vector boundary determining signals MV_EDGE may be accumulated, and the total number EDGE_SUM may be obtained.

If the total number EDGE_SUM is normalized to be turned to the normalized accumulated value EDGE_SUM_NRM by using Expression (9), then the normalized accumulated value EDGE_SUM_NRM becomes a value of 0 to 255 irrespective of an accumulation range of the motion vector boundary determining signals MV_EDGE.

Such normalization by Step S22 of FIG. 16 is not essential; however, even in the case where the accumulation range of the motion vector boundary determining signals MV_EDGE is changed, the normalized accumulated value EDGE_SUM_NRM becomes the value of 0 to 255, and accordingly, such a change of the accumulation range does not affect determination processing in a determiner 135 at a subsequent stage. Accordingly, it is preferable to provide Step S22 and to normalize the total number EDGE_SUM.

The normalized accumulated value EDGE_SUM_NRM is inputted to the determiner 135. The determiner 135 compares the normalized accumulated value EDGE_SUM_NRM and predetermined threshold values TH11, TH12 and TH13 with each other, thereby determines whether or not the image in the frame scrolls entirely and determines the degree of the entire scroll, and outputs the entire scroll degree DS.

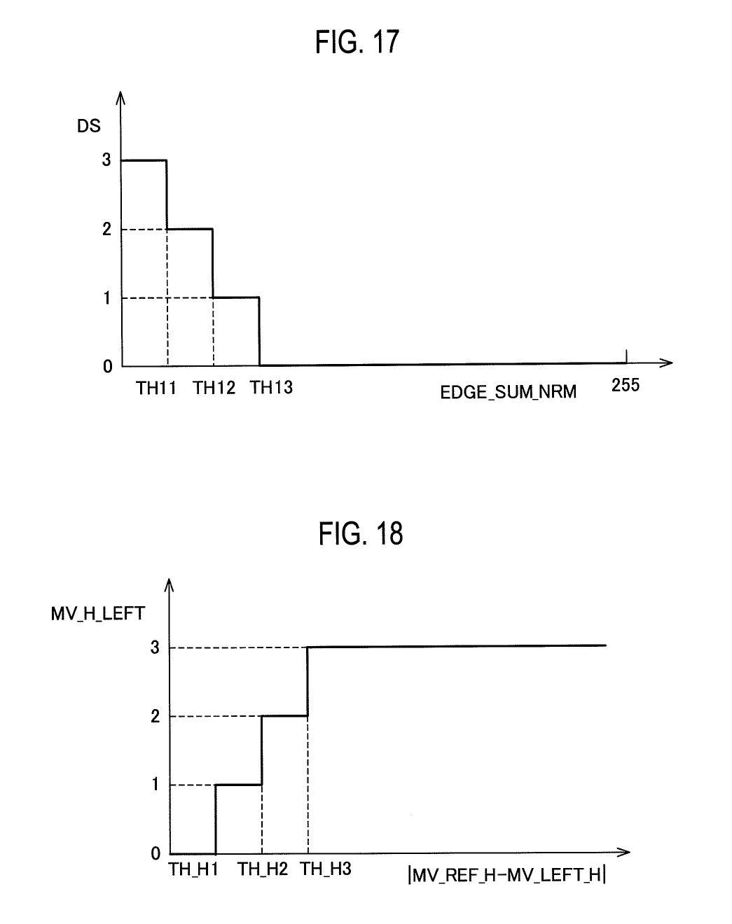

By using FIG. 17, a description is made of characteristics of the entire scroll degree DS to be outputted by the determiner 135. As shown in FIG. 17, three threshold values, which are the threshold values TH11, TH12 and TH13, are provided, and the entire scroll degree DS is set at “3” when the normalized accumulated value EDGE_SUM_NRM is equal to or less than the threshold value TH11, is set at “2” when the normalized accumulated value EDGE_SUM_NRM exceeds the threshold value TH11 and is equal to or less than the threshold value TH12, is set at “1” when the normalized accumulated value EDGE_SUM_NRM exceeds the threshold value TH12 and is equal to or less than the threshold value TH13, and is set at “0” when the normalized accumulated value EDGE_SUM_NRM exceeds the threshold value TH13.

In the second embodiment, first, the motion vector detector 12 detects the motion vectors MV of the image for each predetermined unit of the detection in each of the frames. The boundary determining signal generator 3123 compares the motion vectors MV, which are detected in the different units of the detection in one frame, with each other, thereby determines whether or not the boundary exists in the motion vectors between the different units of the detection, and generates the motion vector boundary determining signal MV_EDGE.

The boundary determining signal accumulator 134 accumulates the motion vector boundary determining signals MV_EDGE, and generates the accumulated value (EDGE_SUM or EDGE_SUM_NRM) indicating the degree at which the boundary between the motion vectors exists in one frame.

Then, the determiner 135 compares the accumulated value and the predetermined threshold values (TH11, TH12, TH13) with each other, thereby generates the entire scroll degree DS indicating the degree at which the image scrolls entirely. The entire scroll determiner 13b just needs to perform relatively simple processing which is the comparison between the motion vectors, the accumulation thereof, and the comparison thereof with the threshold values, and accordingly, can be realized by a small circuit scale. In addition, it is possible to accurately determine the degree of the entire scroll.

In the above-described example, the horizontal motion vector boundary determiner 131 and the vertical motion vector boundary determiner 132 are configured to determine the boundary determining values by the binary values which are “1” and “0”; however, may be configured to determine the same boundary determining values by ternary values.

By using FIG. 18, a description is made of an example where the horizontal motion vector boundary determiner 131 determines the boundary determining value by ternary or more values. FIG. 18 is a characteristic diagram showing an example in the event where the horizontal motion vector boundary determiner 131 generates the boundary determining value MV_H_LEFT. Three threshold values which are threshold values TH_H1, TH_H2 and TH_H3 are provided, and the boundary determining value MV_H_LEFT is represented by quaternary values, which are set at “3” when |MV_REF_{H}−MV_LEFT_H| is larger than the threshold value TH_H3, set at “2” when |MV_REF_{H}−MV_LEFT_H| is equal to or less than the threshold value TH_H3 and larger than the threshold value TH_H2, set at “1” when |MV_REF_H−MV_LEFT_H| is equal to or less than the threshold value TH_H2 and larger than the threshold value TH_H1, and set at “0” when |MV_REF_H−MV_LEFT_H| is equal to or less than the threshold value TH_H1. The boundary determining value MV_H_LEFT indicates that a boundary degree is larger as the value thereof is larger.

FIG. 18 shows characteristics of generating the boundary determining value MV_H_LEFT; however, the horizontal motion vector boundary determiner 131 or the vertical motion vector boundary determiner 132 generates the boundary determining values MV_H_ABOVE, MV_H_LEFT and MV_V_ABOVE according to similar characteristics to those in FIG. 18.

The horizontal motion vector boundary determiner 131 compares the obtained boundary determining value MV_H_LEFT and the obtained boundary determining value MV_H_ABOVE with each other, selects a larger-value one, that is, a value in which the boundary degree is larger, and outputs the selected value as the horizontal motion vector boundary determining signal MV_H_EDGE. In the case where the boundary determining value is determined by ternary or more values, the OR operation is not used. The vertical motion vector boundary determiner 132 also outputs the boundary determining signal MV_V_EDGE by a similar method.

In the boundary determining signal mixer 133, such a procedure is not adopted, in which the OR operation is performed for the horizontal motion vector boundary determining signal MV_H_EDGE and the vertical motion vector boundary determining signal MV_V_EDGE, whereby the motion boundary determining signal MV_EDGE is generated, but a larger-value one between the horizontal motion vector boundary determining signal MV_H_EDGE and the vertical motion vector boundary determining signal MV_V_EDGE, that is, one in which the boundary degree is larger is selected, whereby the motion boundary determining signal MV_EDGE is outputted.

In the event of accumulating the motion vector boundary determining signals MV_EDGE in one frame and obtaining the total number EDGE_SUM, the boundary determining signal accumulator 134 gives some increments to the counter in response to the motion vector boundary determining signals MV_EDGE. For example, if the motion vector boundary determining signals MV_EDGE are 2, then the boundary determining signal accumulator 134 gives two increments to the counter, and if the motion vector boundary determining signals MV_EDGE are 3, then the boundary determining signal accumulator 134 gives three increments to the counter.

In FIG. 11, in a similar way to FIG. 1, the reliability adjuster 15 adjusts the gain of the reliability data DR1 in response to the entire scroll degree DS, and outputs the reliability data DR1, in which the gain is adjusted, as the adjusted reliability data DR2. The interpolation pixel generator 16 adaptively mixes the interpolation pixel Ps and the interpolation pixel Pm with each other in response to the value of the adjusted reliability data DR2, and generates the interpolation pixel Px.

In accordance with the motion compensated frame generating apparatus 102 of the second embodiment, the reliability of the motion vector MV is adjusted by using the entire scroll degree DS, and accordingly, the blurring of the moving picture can be further improved in comparison with the conventional, and the motion compensation quality can be enhanced to a large extent.

In the motion compensated frame generating apparatus 102 of the second embodiment, the entire scroll determiner 13b having the configuration shown in FIG. 12 is used, and accordingly, it becomes possible to accurately determine the degree of the entire scroll by a small circuit scale. Since the degree of the entire scroll can be determined accurately, the improvement effect of the blurring of the moving picture can be enhanced.

### Third Embodiment

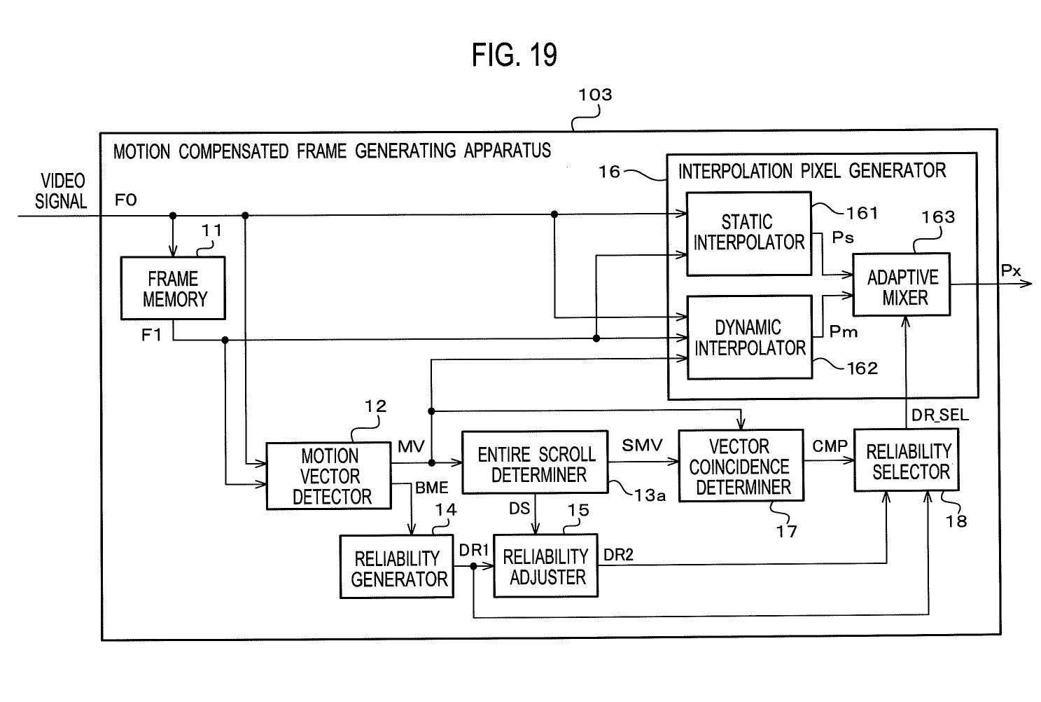

In a motion compensated frame generating apparatus 103 of a third embodiment, which is shown in FIG. 19, the same reference numerals are assigned to the same portions as those of the motion compensated frame generating apparatus 101 of the first embodiment or the motion compensated frame generating apparatus 102 of the second embodiment, and a description thereof is omitted as appropriate. A motion vector detector 12 in the motion compensated frame generating apparatus 103 of the third embodiment may be the same as the motion vector detector 12a of FIG. 1, or may be configured to detect the motion vectors MV without thinning the motion vector candidates MVc.

In the case where the motion vector detector 12 is configured to detect the motion vectors MV without thinning the motion vector candidates MVc, then it is not necessary for the entire scroll determiner 13a to execute the processing of Step S4 in FIG. 4. The entire scroll determiner 13a just needs to compare the histogram value, which corresponds to the maximum value motion vector (mvx_c_hmax, mvy_c_hmax) as the entire scroll motion vector, with the predetermined threshold value with each other, and to generate the entire scroll degree DS.

In the first and second embodiment, as understood from the characteristic diagram of FIG. 8, even in the case where a locally wrong motion vector MV is detected for the image to be entirely scrolled, the adjusted reliability data DR2 adjusted so that the value thereof can be larger than that of the reliability data DR1 is used. As a result, the image quality improvement effect is lowered at the portion where the wrong motion vector MV is detected. The third embodiment is configured so as to prevent a reduction of the image quality improvement effect in the case where the locally wrong motion vector MV is detected.

In FIG. 19, the entire scroll determiner 13a outputs the maximum value motion vector (mvx_c_hmax, mvy_c_hmax), which is obtained in Step S3 in FIG. 4, as an entire scroll motion vector SMV. A vector coincidence determiner 17 as a first example of a vector determiner determines whether or not the motion vector MV and the entire scroll motion vector SMV coincide with each other, and outputs a coincidence determining signal CMP. A horizontal component of the motion vector MV is defined as MVX, a vertical component thereof is defined as MVY, a horizontal component of the entire scroll motion vector SMV is defined as SMVX, a vertical component thereof is defined as SMVY, and X_TH and Y_TH are predetermined threshold values.

In the case where all of Expression (10) to Expression (13) are satisfied, the vector coincidence determiner 17 sets the coincidence determining signal CMP at “1”, and in the case where at least one of Expression (10) to Expression (13) is not satisfied, the vector coincidence determiner 17 sets the coincidence determining signal CMP at “0”.

(SMVX−X_{—}TH)≦MVX (10)

MVX≦(SMVX+X_{—}TH) (11)

(SMVY−Y_{—}TH)≦MVY (12)

MVY≦(SMVY+Y_{—}TH) (13)

To a reliability selector 18, there are inputted: the reliability data DR1 outputted from the reliability generator 14; the adjusted reliability data DR2 outputted from the reliability adjuster 15; and the coincidence determining signal CMP outputted by the vector coincidence determiner 17. If the coincidence determining signal CMP is “1”, then the motion vector MV and the entire scroll motion vector SMV coincide with each other, and accordingly, the reliability selector 18 selects and outputs the adjusted reliability data DR2 as selected reliability data DR_SEL.

Meanwhile, if the coincidence determining signal CMP is “0”, then the motion vector MV and the entire scroll motion vector SMV do not coincide with each other, and accordingly, the reliability selector 18 selects and outputs the reliability data DR1 that has a value smaller than the adjusted reliability data DR2.

The adaptive mixer 163 adaptively mixes the interpolation pixel Ps and the interpolation pixel Pm with each other in response to the value of the selected reliability data DR_SEL outputted from the reliability selector 18. In such a way, in the pixel or the region, where the locally wrong motion vector MV is detected for the image to be scrolled entirely, the interpolation pixel Ps and the interpolation pixel Pm are adaptively mixed with each other in response not to the adjusted reliability data DR2 but to the reliability data DR1, and accordingly, the reduction of the image quality improvement effect can be prevented.

### Fourth Embodiment

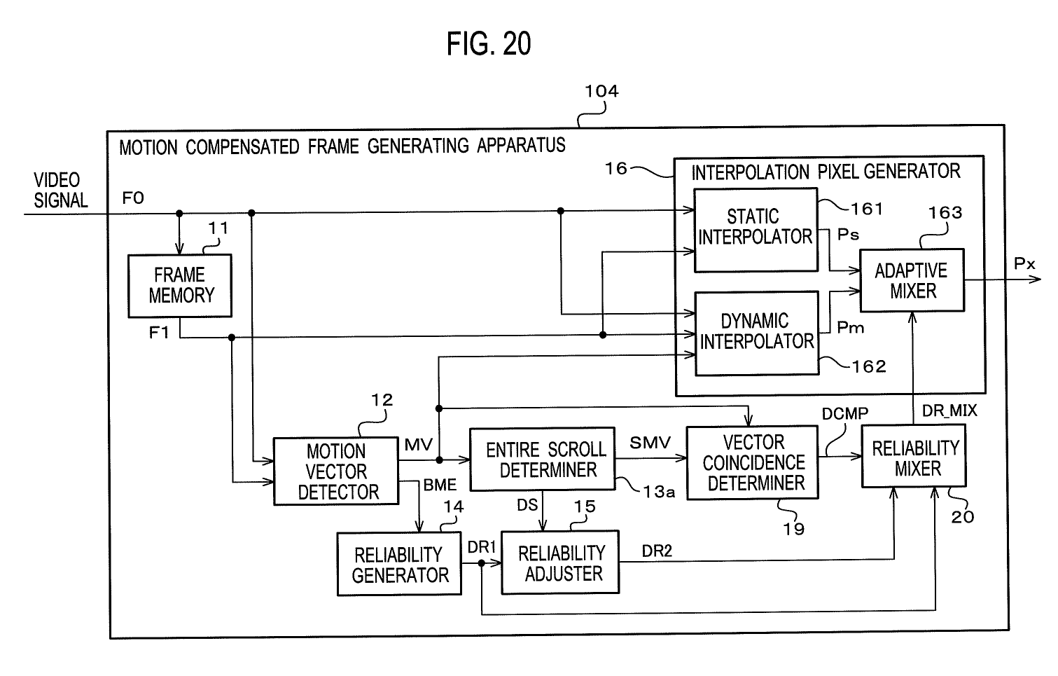

In a motion compensated frame generating apparatus 104 of a fourth embodiment, which is shown in FIG. 20, the same reference numerals are assigned to the same portions as those of the motion compensated frame generating apparatus 101 of the first embodiment, the motion compensated frame generating apparatus 102 of the second embodiment and the motion compensated frame generating apparatus 103 of the third embodiment, and a description thereof is omitted as appropriate. In a similar way to the third embodiment, the fourth embodiment is configured so as to prevent the reduction of the image quality improvement effect in the case where the locally wrong motion vector MV is detected.

In FIG. 20, the entire scroll determiner 13a outputs the maximum value motion vector (mvx_c_hmax, mvy_c_hmax), which is obtained in Step S3 of FIG. 4, as the entire scroll motion vector SMV. A vector coincidence determiner 19 as a second example of the vector determiner determines as to which extent the motion vector MV and the entire scroll motion vector SMV coincide with each other, and outputs a coincidence determining signal DCMP.

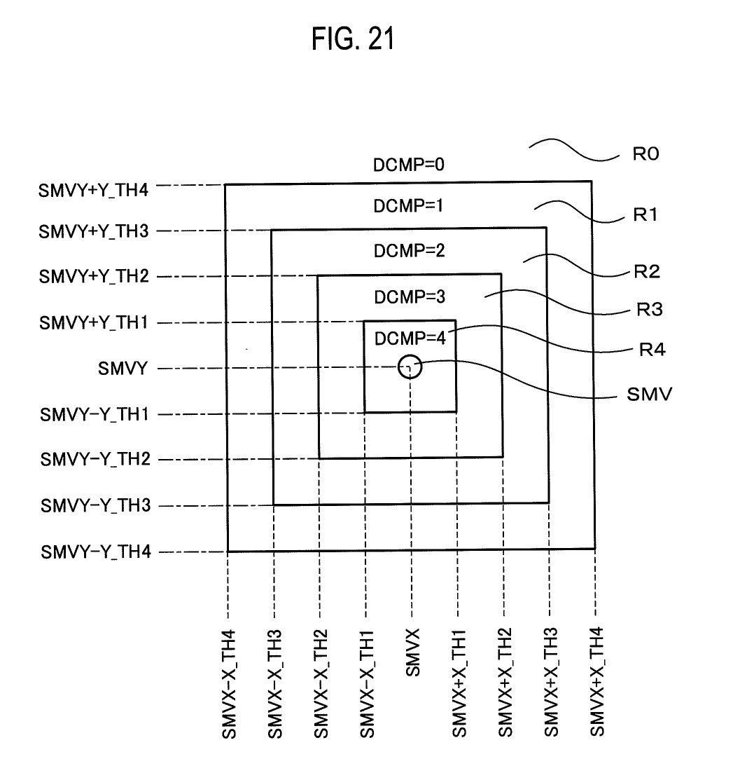

By using FIG. 21, a description is made of a determination method of the coincidence between the motion vector MV and the entire scroll motion vector SMV in the vector coincidence determiner 19. In FIG. 21, X_TH1 to X_TH4 and Y_TH1 to Y_TH4 are predetermined threshold values, where X_TH1≦X_TH2≦X_TH3≦X_TH4 and Y_TH1≦Y_TH2≦Y_TH3≦Y_TH4 are established.

In FIG. 21, the entire scroll motion vector SMV, which is outputted from the entire scroll determiner 13a and is composed of the horizontal component SMVX and the vertical component SMVY, is shown by a circle at a center of FIG. 21. A region R4 is a portion of a range of ±X_TH1 from the horizontal component SMVX of the entire scroll motion vector SMV, and of ±Y_TH1 from the vertical component SMVY thereof.

A region R3 is a portion, which excludes the region R4, in a range of ±X_TH2 from the horizontal component SMVX of the entire scroll motion vector SMV, and of ±Y_TH2 from the vertical component SMVY thereof. A region R2 is a portion, which excludes the regions R3 and R4, in a range of ±X_TH3 from the horizontal component SMVX of the entire scroll motion vector SMV, and of ±Y_TH3 from the vertical component SMVY thereof.

A region R1 is a portion, which excludes the regions R2 to R4, in a range of ±X_TH4 from the horizontal component SMVX of the entire scroll motion vector SMV, and of ±Y_TH4 from the vertical component SMVY thereof. A region R0 is a portion on an outside of a region R1, which goes beyond ±X_TH4 from the horizontal component SMVX of the entire scroll motion vector SMV, and goes beyond ±Y_TH4 from the vertical component SMVY thereof.

The above-described regions are represented by the following expressions. It is the region R4 that satisfies all of Expression (14) to Expression (17). In the case where all of Expression (14) to Expression (17) are satisfied, the vector coincidence determiner 19 determines that the coincidence between the motion vector MV and the entire scroll motion vector SMV is highest, and sets the coincidence determining signal DCMP at “4”.

(SMVX−X_{—}TH1)≦MVX (14)

MVX≦(SMVX+X_{—}TH1) (15)

(SMVY−Y_{—}TH1)≦MVY (16)

MVY≦(SMVY+Y_{—}TH1) (17)

It is the region R3 that does not satisfy any of Expression (14) to Expression (17), and satisfies all of Expression (18) to Expression (21). In the case where any of Expression (14) to Expression (17) is not satisfied, and all of Expression (18) to Expression (21) are satisfied, the vector coincidence determiner 19 determines that the coincidence between the motion vector MV and the entire scroll motion vector SVM is high next to the region R4, and sets the coincidence determining signal DCMP at “3”.

(SMVX−X_{—}TH2)≦MVX (18)

MVX≦(SMVX+X_{—}TH2) (19)

(SMVY−Y_{—}TH2)≦MVY (20)

MVY≦(SMVY+Y_{—}TH2) (21)

It is the region R2 that does not satisfy any of Expression (18) to Expression (21), and satisfies all of Expression (22) to Expression (25). In the case where any of Expression (18) to Expression (21) is not satisfied, and all of Expression (22) to Expression (25) are satisfied, the vector coincidence determiner 19 determines that the coincidence between the motion vector MV and the entire scroll motion vector SVM is high next to the region R3, and sets the coincidence determining signal DCMP at “2”.

(SMVX−X_{—}TH3)≦MVX (22)

MVX≦(SMVX+X_{—}TH3) (23)

(SMVY−Y_{—}TH3)≦MVY (24)

MVY≦(SMVY+Y_{—}TH3) (25)

It is the region R1 that does not satisfy any of Expression (22) to Expression (25), and satisfies all of Expression (26) to Expression (29). In the case where any of Expression (22) to Expression (25) is not satisfied, and all of Expression (26) to Expression (29) are satisfied, the vector coincidence determiner 19 determines that the coincidence between the motion vector MV and the entire scroll motion vector SVM is high next to the region R2, and sets the coincidence determining signal DCMP at “1”.

(SMVX−X_{—}TH4)≦MVX (26)

MVX≦(SMVX+X_{—}TH4) (27)

(SMVY−Y_{—}TH4)≦MVY (28)

MVY≦(SMVY+Y_{—}TH4) (29)

It is the region R0 that does not satisfy any of Expression (26) to Expression (29). In the case where any of Expression (26) to Expression (29) is not satisfied, the vector coincidence determiner 19 determines that the coincidence between the motion vector MV and the entire scroll motion vector SVM is low, and sets the coincidence determining signal DCMP at “0”.

In the example shown in FIG. 21, the coincidence determining signal DCMP is classified into five stages; however, the number of stages of the coincidence determining signal DCMP is not limited to this. The number of stages of the coincidence determining signal DCMP may be increased by increasing the number of threshold values.

To a reliability mixer 20, there are inputted: the reliability data DR1 outputted from the reliability generator 14; the adjusted reliability data DR2 outputted from the reliability adjuster 15; and the coincidence determining signal DCMP outputted from the vector coincidence determiner 19. Based on Expression (30), the reliability mixer 20 mixes the reliability data DR1 and the adjusted reliability data DR2 with each other, and outputs a resultant mixture as mixed reliability data DR_MIX.

DR_MIX=DR2×DCMP/4+DR1×(1−DCMP/4) (30)

As understood from Expression (30), if the coincidence determining signal DCMP is “4”, then the mixed reliability data DR_MIX becomes the adjusted reliability data DR2. If the coincidence determining signal DCMP is “3”, then the mixed reliability data DR_MIX becomes a value obtained by mixing the reliability data DR1 and the adjusted reliability data DR2 with each other in a state where a ratio of the adjusted reliability data DR2 is increased.

If the coincidence determining signal DCMP is “2”, then the mixed reliability data DR_MIX becomes a value obtained by evenly mixing the reliability data DR1 and the adjusted reliability data DR2 with each other. If the coincidence determining signal DCMP is “1”, then the mixed reliability data DR_MIX becomes a value obtained by mixing the reliability data DR1 and the adjusted reliability data DR2 with each other in a state where a ratio of the reliability data DR21 is increased. If the coincidence determining signal DCMP is “0”, then the mixed reliability data DR_MIX becomes the reliability data DR1.

The adaptive mixer 163 adaptively mixes the interpolation pixel Ps and the interpolation pixel Pm with each other in response to a value of the mixed reliability data DR_MIX outputted from the reliability mixer 20.

In such a way, in the pixel or the region, where the locally wrong motion vector MV is detected for the image to be entirely scrolled, the interpolation pixel Ps and the interpolation pixel Pm are adaptively mixed with each other in response not to the adjusted reliability data DR2 but to the reliability data DR1, and the interpolation pixel Ps and the interpolation pixel Pm are adaptively mixed with each other in response to the mixed reliability data DR_MIX obtained by mixing the reliability data DR1 and the adjusted reliability data DR2 depending on a degree of a difference between the locally wrong motion vector MV and the entire scroll vector SMV. Hence, the reduction of the image quality improvement effect can be prevented.

Incidentally, in the motion compensated frame generating apparatus 103 of the third embodiment, in the vector coincidence determiner 17 as the first example of the vector determiner, the degree of the coincidence between the motion vector MV and the entire scroll vector SMV is determined at two stages.

In the motion compensated frame generating apparatus 104 of the fourth embodiment, in the vector coincidence determiner 19 as the second example of the vector determiner, the degree of the coincidence between the motion vector MV and the entire scroll vector SMV is determined at five stages. That is to say, the motion compensated frame generating apparatus 104 increases the number of stages for the determination of the degree of the coincidence between the motion vector MV and the entire scroll motion vector SMV more than in the determination in the motion compensated frame generating apparatus 103.

Moreover, in the motion compensated frame generating apparatus 103, in the reliability selector 18, the selected reliability data DR_SEL, which selectively outputs the reliability data DR1 and the adjusted reliability data DR2, is generated.

In the motion compensated frame generating apparatus 104, in the reliability mixer 20, the mixed reliability data DR_MIX is generated, which selects the case of using only the reliability data DR1, the case of using only the adjusted reliability data DR2, and the case of using both of the reliability data DR1 and the adjusted reliability data DR2. That is to say, in the motion compensated frame generating apparatus 104, a state of using both of the reliability data DR1 and the adjusted reliability data DR2 is added to a state of selectively using only either one of the reliability data DR1 and the adjusted reliability data DR2 as in the motion compensated frame generating apparatus 103.

The present invention is not limited to the first to fourth embodiments described above, and is changeable in various ways within the scope without departing from the spirit thereof. The present invention may be composed of hardware, or may be composed of software (computer program). The hardware and the software may be mixedly used, and selection and a ratio of use between the hardware and the software are arbitrary.

In the first to fourth embodiments, as an example, the motion compensated frame generating apparatus that doubles the frame rate is described; however, the motion compensated frame generating apparatus is not limited to this. The present invention can also be used for a motion compensated frame generating apparatus that upconverts the frame rate into a frame rate three times, four times or the like as well as twice the original frame rate concerned. Moreover, the present invention can also be used for a film judder removal apparatus and the like.

What is claimed is:

1. A motion compensated frame generating apparatus comprising:
a motion vector detector configured to define, as a focused unit of detection, a predetermined unit of detection in an actual frame in a video signal, to detect a motion vector directed toward a unit of detection, the unit having a highest correlation with the focused unit of detection, by using block matching from among a plurality of motion vector candidates directed toward plural units of detection, the units being included in a predetermined search range in another actual frame, and to output a block matching error value individually for the focused unit of detection, the block matching error value corresponding to the motion vector;
an entire scroll determiner configured to, based on the motion vector, generate an entire scroll degree indicating a degree at which an image scrolls entirely;
a reliability generator configured to, based on the block matching error value, generate reliability data indicating reliability of the motion vector;
a reliability adjuster configured to adjust the reliability data so that a value of the reliability data is larger as the entire scroll degree is a value in which the degree at which the image scrolls entirely is larger, and to output the reliability data as adjusted reliability data; and
an interpolation pixel generator configured to, based on the adjusted reliability data, increase a ratio of dynamic interpolation processing that uses the motion vector between static interpolation processing that does not use the motion vector and the dynamic interpolation processing as the reliability of the motion vector is larger, and to generate respective interpolation pixels composing a motion compensated frame,
wherein the entire scroll determiner includes:
a boundary determining signal generator configured to compare the motion vectors between different units of detection in one actual frame among the motion vectors detected by the motion vector detector, thereby to determine whether or not a boundary between the motion vectors in the different units of detection exists, and to generate a motion vector boundary determining signal;
a boundary determining signal accumulator configured to accumulate a plurality of the motion vector boundary determining signals generated by the boundary determining signal generator, and to generate an accumulated value indicating a degree at which the boundary between the motion vectors exists in one actual frame; and
a determiner configured to compare the accumulated value and a predetermined threshold value with each other, and thereby to generate the entire scroll degree.

2. The motion compensated frame generating apparatus according to claim 1,
wherein the interpolation pixel generator includes:
a static interpolator configured to generate a static interpolation pixel by the static interpolation processing;
a dynamic interpolator configured to generate a dynamic interpolation pixel by the dynamic interpolation processing; and
an adaptive mixer configured to adaptively mix the static interpolation pixel and the dynamic interpolation pixel in response to a value of the adjusted reliability data.

3. A motion compensated frame generating method comprising:
defining, as a focused unit of detection, a predetermined unit of detection in an actual frame in a video signal, and calculating, by block matching, a degree of correlation of each of a plurality of motion vector candidates directed from the focused unit of detection toward plural units of detection, the units being included in a predetermined search range in another actual frame, with the focused unit of detection;
detecting a motion vector directed toward a unit of detection, the unit having a highest correlation with the focused unit of detection, among the plurality of motion vector candidates;
outputting a degree of correlation individually for the focused unit of detection as a block matching error value, the block matching error value corresponding to the motion vector;
based on the motion vector, generating an entire scroll degree indicating a degree at which an image scrolls entirely;
based on the block matching error value, generating reliability data indicating reliability of the motion vector;
adjusting the reliability data so that a value of the reliability data is larger as the entire scroll degree is a value in which the degree at which the image scrolls entirely is larger, and outputting the reliability data as adjusted reliability data; and
based on the adjusted reliability data, increasing a ratio of dynamic interpolation processing that uses the motion vector between static interpolation processing that does not use the motion vector and the dynamic interpolation processing as the reliability of the motion vector is larger, and generating respective interpolation pixels composing a motion compensated frame,
wherein the generating the entire scroll degree includes:
comparing the motion vectors between different units of detection in one actual frame among the motion vectors detected by the detecting a motion vector, thereby determining whether or not a boundary between the motion vectors in the different units of detection exists, and generating a motion vector boundary determining signal;
accumulating a plurality of the motion vector boundary determining signals, and generating an accumulated value indicating a degree at which the boundary between the motion vectors exists in one actual frame; and
comparing the accumulated value and a predetermined threshold value with each other, and thereby generating the entire scroll degree.

4. The motion compensated frame generating method according to claim 3,
wherein the generating interpolation pixels includes:
generating a static interpolation pixel by the static interpolation processing;
generating a dynamic interpolation pixel by the dynamic interpolation processing; and
adaptively mixing the static interpolation pixel and the dynamic interpolation pixel in response to a value of the adjusted reliability data.
